(19) United States
(12) Patent Application Publication
(10) Pub. No.: US 2009/0311981 A1
(43) Pub. Date: Dec. 17, 2009

(54) TUNER MODULE

(76) Inventors: Junichi NORO, Tokyo (JP); Satoshi SATO, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/485,357

(22) Filed: Jun. 16, 2009

(30) Foreign Application Priority Data
Jun. 16, 2008 (JP) P2008-156188

(51) Int. Cl. H04B 1/18; H01P 11/00

(52) U.S. Cl. 455/150.1; 29/600

(57) ABSTRACT

A tuner module adapted to demodulate a signal received by an antenna device is disclosed. An electric device is mounted on a circuit board. A die-casted chassis is made of a conductive material and monolithically has a tubular part. A signal transmitting member is coaxially disposed in the tubular part and constitutes a coaxial connector with the tubular part. The signal transmitting member is electrically connected to the electric device to transmit the signal received by the antenna device to the electric device.

### BACKGROUND

The present invention relates to a tuner module for radio receivers and in particular to a tuner module suited for vehicle-mounted digital radio receivers capable of receiving radio waves coming from an artificial satellite (hereinafter referred to as satellite waves) or waves on the ground (hereinafter referred to as terrestrial waves) and receiving digital radio broadcasts.

Recently, digital radio receivers are developed capable of receiving satellite waves or terrestrial waves and receiving digital radio broadcasts and are in commercial use in the U.S.A. Such a digital radio receiver may be mounted on a mobile station, for example an automobile, and is capable of receiving radio waves in a band of frequencies around 2.3 GHz and receiving radio broadcasts. In other words, the digital radio receiver is a radio receiver capable of receiving mobile broadcasts. The frequency of received radio waves is approximately 2.3 GHz so that the corresponding receiving wavelength (resonant wavelength) λ is about 128.3 mm. Satellite waves are once received by a ground station and converted into linear-polarized waves with certain frequency shift, and the resultant waves are retransmitted as terrestrial waves. That is, satellite waves are circularly polarized waves while terrestrial waves are linearly polarized waves.

In this way, digital radio broadcasts use radio waves in a band of frequencies around 2.3 GHz. Thus, an antenna for receiving the radio waves is often arranged outdoors. In case a digital radio receiver is mounted on an automobile, the antenna is mounted on the roof of the automobile. Such an antenna for automobiles and a receiver main unit (head unit) installed in the cabin of an automobile are electrically connected to each other via cables. The head unit operates as an external device.

This type of receiver system for receiving satellite waves or terrestrial waves includes an antenna part (antenna device) and a tuner part (satellite radio tuner part). The antenna part receives satellite waves or terrestrial waves and outputs high-frequency signals. The tuner part demodulates the high-frequency signals and outputs sound signals.

Electronic components that constitute such a tuner part are usually mounted on a printed circuit board and housed in a metallic case also serving as a shield (for example, refer to Patent Document 1).

In general, a satellite digital radio receiver includes an antenna, a tuner part, a signal demodulator, a channel demodulator, a sound decoder, a data decoder, a controller, and an operation part (for example, refer to Patent Document 2).

A tuner module is known that includes a printed circuit board. The tuner module disclosed in Patent Document 3 includes a printed circuit board, an RF input part formed on the printed circuit board in order to input high-frequency received signals received by an antenna device, and electronic components mounted on the printed circuit board in order to demodulate the receive signal and output a sound signal. To the RF input part is connected an RF connector including a signal pin and a ground pin. The printed circuit board is accommodated in a metallic case made of aluminum. The metallic case is composed of a pair of die-cast-molded cases made of aluminum that sandwiches the printed circuit board.

An electronic circuit unit is also known where a frame body also serves as the first outer conductor of a first coaxial connector. The electronic circuit unit disclosed in Patent Document 4 includes a frame body including a side plate composed of a metallic plate, a first coaxial connector arranged on the frame body, and a circuit board arranged in the frame body. The first coaxial connector is composed of a first outer conductor composed of a projection protruding outward from the side plate perpendicularly thereto, an insulating body arranged in the first outer conductor, and a first core conductor mounted in the first outer conductor while insulated from the same by the insulating body. The first outer conductor is arranged, with press drawing or the like, on one of the side plates of the frame body. The first outer conductor includes a cylindrical part composed of a projection protruding outward from a side plate perpendicularly thereto, and a through hole in the core of the cylindrical part. In the through hole in the first outer conductor is arranged the insulating body by way of press fitting or molding. The first core conductor is mounted with the insulating body.

A second coaxial connector is connected to the first coaxial connector. The second coaxial connector is composed of a second cylindrical outer conductor, an insulating body arranged in the second outer conductor, and a second core conductor mounted in the second outer conductor while insulated from the same by the insulating body. To the first and second coaxial connectors are connected the first and second outer conductors as well as the first and second core conductors.

[Patent Document 1] Japanese Patent Publication No. 06-209268 A

[Patent Document 2] Japanese Patent Publication No. 2002-344335 A

[Patent Document 3] Japanese Patent Publication No. 2008-78701 A

[Patent Document 4] Japanese Patent Publication No. 2003-219316 A

A conventional tuner module 100 disclosed in Patent Document 3 will be described referring to FIGS. 1 to 5 in order to facilitate understanding of the invention. In FIGS. 1 to 5, the back-and-forth direction is represented by the X-axis direction, the horizontal direction by the Y-axis direction, and the vertical direction by the Z-axis direction. The illustrated tuner module 100 shows an example which the tuner module 100 is mounted on a major face of the main board in an orientation that the longitudinal direction thereof is directed orthogonal to the major face (longitudinal mount). Note that the invention is also applicable to a case which the tuner module is mounted on the main board in an orientation that the longitudinal direction thereof is directed parallel to the major face (facedown mount).

FIGS. 1 to 3 show a case where the tuner part, demodulator, sound decoder, data decoder and the controller for controlling these among the components of a vehicle-mounted digital radio receiver are mounted on a single printed circuit board and the printed circuit board is accommodated in a metallic case. This configuration is herein referred to as a tuner module.

Referring to FIGS. 1 and 2, a tuner module 100 includes a metallic chassis 10 and a printed circuit board 20. The metallic chassis 10 is composed of a front chassis 11 and a rear chassis 12 as aluminum die-cast molds. In case the tuner module 100 is arranged in landscape orientation, the front chassis 11 is used as a lower chassis and the rear chassis 12 as an upper chassis. In this case, connector pins (described later) mounted on the printed circuit board 20 are arranged in a different way.

The front chassis 11 is shaped into a rectangular solid extending in parallel with a Y-Z plane parallel to the Y-axis direction and the Z-axis direction. The front chassis 11 includes a top side 11a and a bottom side 11b opposed each other in the vertical direction and a left side 11c and a right side 11d opposed each other in the Y-axis direction. The front chassis 11 includes a front face 11e and a rear face 11f opposed each other in the X-axis direction.

Similarly, the rear chassis 12 is shaped into a rectangular solid shape extending in parallel with the Y-Z plane. The rear chassis 12 includes a top side 12a and a bottom side 12b opposed each other in the vertical direction and a left side 12c and a right side 12d opposed each other in the Y-axis direction. The rear chassis 12 includes a front face 12e and a rear face 12f opposed each other in the X-axis direction.

The printed circuit board 20 extends in parallel with the Y-Z plane. The printed circuit board 20 includes a top side 20a and a bottom side 20b opposed each other in the Z-axis direction and a left side 20c and a right side 20d opposed each other in the Y-axis direction. The printed circuit board 20 includes a front face 20e and a rear face 20f opposed each other in the X-axis direction. On the side of the front face 20e of the printed circuit board 20 is arranged the front chassis 11. On the side of the rear face 20e of the printed circuit board 20 is arranged the rear chassis 12.

The printed circuit board 20 is accommodated in the space between the front chassis 11 and the rear chassis 12 to provide shielding except for portions where is required to be electrically connected to the outside (described later), so that a shield is provided. The printed circuit board 20 is fixed by using first to fifth board fixing screws (described later) while sandwiched between the front chassis 11 and the rear chassis 12.

The front chassis 11 is formed with first to fifth front screw holes 111, 112, 113, 114 and 115 into which the first to fifth board fixing screws are respectively screwed. The first front screw hole 111 is arranged in the upper left corner of the front chassis 11. The second front screw hole 112 is arranged in the lower left corner of the front chassis 11. The third front screw hole 113 is arranged on the top side 11a near the right side 11d of the front chassis 11. The fourth front screw hole 114 is arranged in the lower right corner of the front chassis 11. The fifth front screw hole 115 is arranged on the bottom side 11b inward from the fourth screw hole 114.

The rear chassis 12 has a first rear screw boss 121 including therein a screw hole into which the first board fixing screw is screwed in a position corresponding to the first front screw hole 111, and a second rear screw boss 122 including therein a screw hole into which the second board fixing screw is screwed in a position corresponding to the second front screw hole 112. The rear chassis 12 has a third rear screw boss 123 including therein a screw hole into which the third board fixing screw is screwed in a position corresponding to the third front screw hole 113. While not illustrated, the rear chassis 12 has fourth and fifth rear screw holes into which the fourth and fifth board fixing screws are respectively screwed in positions corresponding to the fourth and fifth front screw holes 114 and 115.

The printed circuit board 20 is formed with a first through hole 201 into which the first rear screw boss 121 is inserted in a position corresponding to the first front screw hole 111, and a second through hole 202 into which the second rear screw boss 122 is inserted in a position corresponding to the second front screw hole 112. The printed circuit board 20 is formed with a third through hole 203 into which the third rear screw boss 123 is inserted in a position corresponding to the third front screw hole 113. Further, the printed circuit board 20 is formed with fourth and fifth through holes 204 and 205 through which the fourth and fifth board fixing screws are respectively passed in positions corresponding to the fourth and fifth front screw holes 114 and 115.

As shown in FIG. 3A, the rear face 20f of the printed circuit board 20 mounts thereon a first IC component 21 as a major component of the tuner part and a second IC component 22 as a major component of the demodulator. As shown in FIG. 3B, the front face 20e of the printed circuit board 20 mounts thereon a third IC component 23 as a major component of the controller.

As shown in FIG. 1, the rear face (inner wall surface) 11f of the front chassis 11 coming into contact with the front face 20e of the printed circuit board 20 is formed with a concave part 117 corresponding to the size of an electronic component or an electronic component group (arrangement of a plurality of electronic components adjacent to each other) to be mounted on the printed circuit board 20. Similarly, as shown in FIG. 2, the front face (inner wall surface) 12e of the rear chassis 12 coming into contact with the rear face 20f of the printed circuit board 20 is formed with a concave part 127 corresponding to the size of an electronic component or an electronic component group to be mounted on the printed circuit board 20. This makes the thickness of the tuner module 100 reduced. It goes without saying that a conductor pattern formed on the printed circuit board 20 and a component that must not be short-circuited are arranged so as not to be contact the metallic case 10 or are insulated.

Referring to FIG. 1, heat conduction sheets 32, 33 are bonded to the upper face (entire face in this example) of the second and third IC components 22 and 23 among the first through third IC components 21 to 23 or to the inner face of the corresponding metallic chassis 10 (front face 12e of the rear case 12 and rear face 11f of the front case 11). The heat conduction sheets 32, 33 respectively adhere, with face contact, to the second IC component 22 and the front face 12e of the rear chassis 12 and the third IC component 23 and the rear face 11f of the front chassis 11. The material of a heat conduction sheet may be silicon rubber, acrylic rubber, graphite, or the like.

Heat dissipation sheets 42, 43 are bonded respectively to the outer face of the metallic chassis 10, that is, to the rear face (outer face) 12f of the rear chassis 12 and to the front face (outer face) 11e of the front chassis 11 in regions including regions corresponding to the heat conduction sheets 32, 33. The regions where the heat dissipation sheets 42, 43 are bonded preferably include the regions where the heat conduction sheets 32, 33 are bonded, although the regions where the heat dissipation sheets 42, 43 may be arranged off the regions where the heat conduction sheets 32, 33. The material of a heat dissipation sheet may be a mixed material of liquid ceramic and glass cloth.

As shown in FIG. 1, on the bottom side 20b of the printed circuit board 20 is mounted a connector pin 25 to be inserted into a wiring pattern on the main board (not shown). The front chassis 11 is formed with a rectangular front notch 118 for a connector in the position on the bottom side 11b corresponding to the mounting position of the connector pin 25. Similarly, the rear chassis 12 is formed with a rectangular front notch 128 for a connector in the position on the bottom side 12b corresponding to the mounting position of the connector pin 25.

The printed circuit board 20 includes, in its upper right corner, an RF input part 209 for inputting radio-frequency (RF) received signals from an antenna device (not shown). The front chassis 11 is formed with a rectangular front concave part 119 for RF input in the position on the right side 11d corresponding to the RF input part 209. Similarly, the rear chassis 12 is formed with a rectangular rear notch 129 in the position on the right side 12d corresponding to the RF input part 209. The RF input part 209 has a specific pattern compatible with both a coaxial cable and an RF connector.

The illustrated tuner module 100 is mounted on the major face of the main board in an orientation that the longitudinal direction thereof is directed orthogonal to the major face (longitudinal mount) while held thereon with a bracket (not shown). The bracket is mounted on the tuner module 100 by way of first to fourth mounting screws (not shown). The material of the bracket is steel or galvanized steel so that the bracket may be soldered to the main board.

As shown in FIG. 2, first to fourth front screw bosses 151 to 154 protrude forward from the front face 11e. The first to fourth bosses include therein screw holes into which the first to fourth mounting screws are screwed. The first to fourth front screw bosses 151 to 154 are respectively arranged near the first to fourth front screw holes 111 through 114. First and second positioning projections protrude forward from the front face 11e for positioning a bracket. The first positioning projection 156 is arranged near the first front screw boss 151. The second positioning projection 157 is arranged near the fourth front screw boss 154.

FIGS. 4 and 5 show the state where an RF connector 92 is electrically connected to the RF input part 209.

As shown in FIG. 5, the RF connector 92 includes one signal pin 921 protruding from the bottom side 20b and four ground pins 922 arranged around the signal pin.

The signal pin 921 of the RF connector 92 is inserted into a through hole (not shown) in the RF input part 209. The four ground pins 922 of the RF connector 92 are inserted into four ground pins inserting holes (not shown) in the RF input part 209. The signal pin 921 and the through hole are electrically connected by soldering on the front face 20e. The four ground pins 922 and the four ground pin inserting holes are electrically connected to each other via soldering on the front face 20e.

The RF connector 92 includes an RF housing 925 and an RF signal transmitting member (not shown) housed in the RF housing 925. The RF connector 92 is designed to couple with a mating connector (described later).

To be more specific, the RF housing 925 includes a cylindrical RF outer casing 925-1, a claw 925-2 arranged on the outer wall of the RF outer casing 925-1, and a pair of guide projecting strips 925-3 arranged on the outer wall of the RF outer casing 925-1. The claw 925-2 is engaged to a hole made in a mating housing of a mating connector. The pair of guide projecting strips 925-3 is inserted into a pair of guide grooves arranged on an RF housing of the mating connector.

An RF signal transmitting member of the RF connector 92 is composed of a signal pin (RF core conductor) 921 and an RF insulating body arranged between the signal pin 921 and the RF housing (RF outer conductor) 925. Similarly, a mating signal transmitting member of the mating connector is composed of a mating core conductor and a mating insulating body arranged between the mating core conductor and a mating housing.

When the mating connector is coupled to the RF connector 92, the RF housing and the mating housing are electrically connected each other and the signal pin 921 and the mating core conductor of the mating connector are electrically connected each other.

The RF connector 92 has a male connector, and the mating connector has a female connector. One end of a coaxial cable is connected the mating connector. The other end of the coaxial cable is connected an antenna device.

As described above, the die-cast-molded metallic chassis 10 is separate from the RF connector 92 on the related art tuner module 100. This causes the number of parts to be increased. When the RF connector 92 is mounted on the RF input part 209 of the printed circuit board 20, it is necessary to solder five terminals as shown in FIG. 5. This increases the number of assembling steps.

The RF housing 925 has a complicated configuration including the claw 925-2 and the pair of guide strips 925-3. Thus, as disclosed in the Document 4, it is difficult to fabricate the RF outer conductor 925 of the RF connector 92 by way of sheet-metal working.

With the electronic circuit unit disclosed in Patent Document 4, the frame body is composed of a sheet metal chassis made by sheet metal working. The first outer conductor of the first coaxial connector is arranged on the side face of the frame body by way of press drawing or the like. The frame body is fabricated by sheet metal working and bending work is restricted a pulling direction of the sheet metal. That is, when the frame body fabricated by sheet metal working, it is difficult to add the first outer conductor having a complicated structure to the frame body.

### SUMMARY

It is therefore one advantageous aspect of the present invention to provide a tuner module capable of reducing the number of parts.

It is therefore one advantageous aspect of the present invention to provide a tuner module capable of reducing the number of assembling steps.

It is therefore one advantageous aspect of the present invention to provide a tuner module having a chassis including a connector housing having a complicated structure.

According to one aspect of the invention, there is provided a tuner module adapted to demodulate a signal received by an antenna device, the tuner module comprising:

a die-casted chassis made of a conductive material and monolithically having a tubular part;

a circuit board disposed in the chassis;

an electric device mounted on the circuit board; and

a signal transmitting member coaxially disposed in the tubular part and constituting a coaxial connector with the tubular part, the signal transmitting member being electrically connected to the electric device to transmit the signal received by the antenna device to the electric device.

The tuner module may be configured such that: the chassis includes a first part and a second part sandwiching the circuit board; and the first part monolithically has the tubular part.

The tuner module may be configured such that: the signal transmitting member includes: a conductive core wire configured to transmit the signal to the electric device; and a dielectric member surrounding the conductive core wire.

The tuner module may be configured such that: the coaxial connector is adapted to be coupled to a mating connector having a hole; and the tubular part is formed with a claw adapted to be engaged with the hole when the coaxial connector is coupled to the mating connecter.

The tuner module may be configured such that: the tubular part is formed with a guide projection on an outer circumferential face thereof adapted to be inserted into a guide slit formed on the mating connector, when the coaxial connector is coupled to the mating connecter.

The tuner module may be configured such that: the signal transmitting member is configured to transmit a radio frequency signal.

The tuner module may be configured such that: the chassis is configured to electromagnetically shield the electronic device.

According to one aspect of the invention, there is provided a method of assembling a tuner module adapted to demodulate a signal received by an antenna device, the method comprising:

die-casting a chassis with a conductive material so as to monolithically have a tubular part;

disposing a circuit board mounting an electric device thereon in the chassis;

disposing a signal transmitting member configured to transmit the signal in the tubular part coaxially so as to constitute a coaxial connector with the tubular part; and

connecting the signal transmitting member to the electric device electrically.

### BRIEF DESCRIPTION OF DRAWINGS

FIG. 1 is a perspective view showing a configuration of a conventional tuner module.

FIG. 2 is a perspective view showing the conventional tuner module.

FIG. 3A is a back view showing a rear face of a printed circuit board of the conventional tuner module.

FIG. 3B is a front view in upside down showing a front face of the printed circuit board.

FIG. 4 is a perspective view of the rear face of the printed circuit board to which an RF connector is connected.

FIG. 5 is a perspective view of the front face of the printed circuit board to which the RF connector is connected.

FIG. 6 is a perspective view of a rear chassis and an RF connector according to one embodiment of the present invention in a disassembled state.

FIG. 7 is a perspective view of the assembly of the RF connector mounted of the rear chassis.

FIG. 8 is a perspective view of the assembly of the RF connector mounted of the rear chassis.

FIG. 9 is a front view of a mating connector of the RF connector.

FIG. 10 is a plan view of the mating connector.

FIG. 11 is a plan view showing the mating connector fitted to the RF connector.

### DETAILED DESCRIPTION OF EXEMPLIFIED EMBODIMENTS

Exemplified embodiments of the invention are described below in detail with Document to the accompanying drawings.

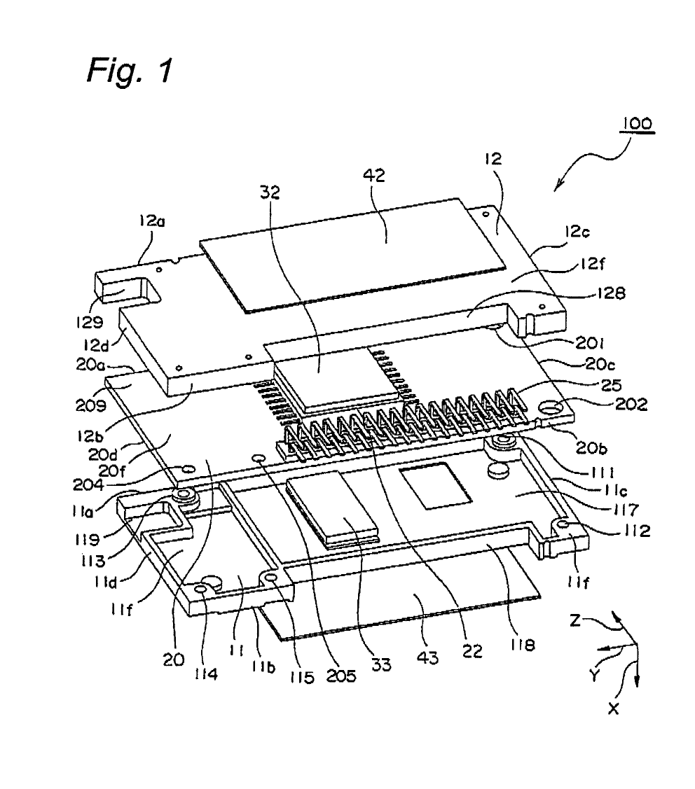

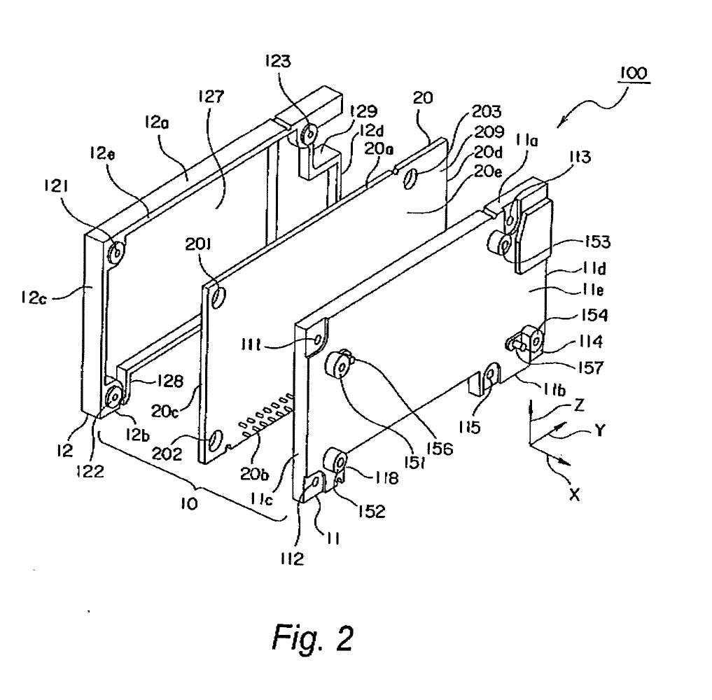

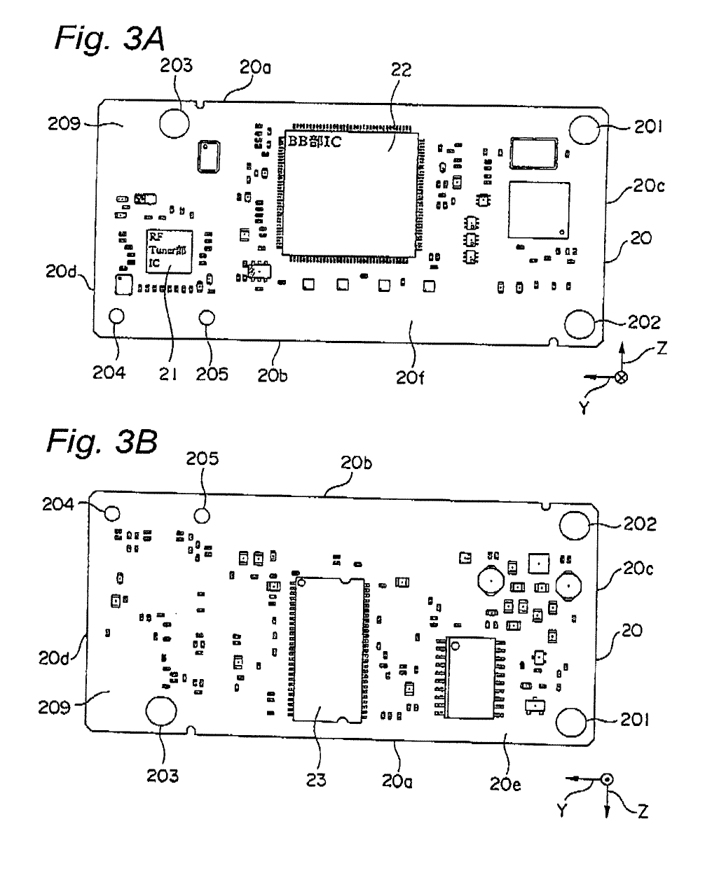

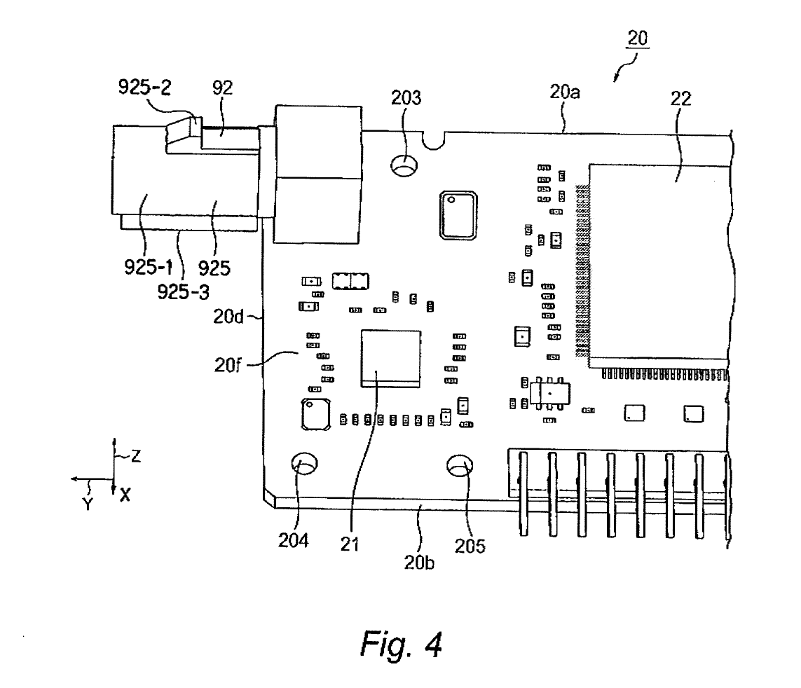

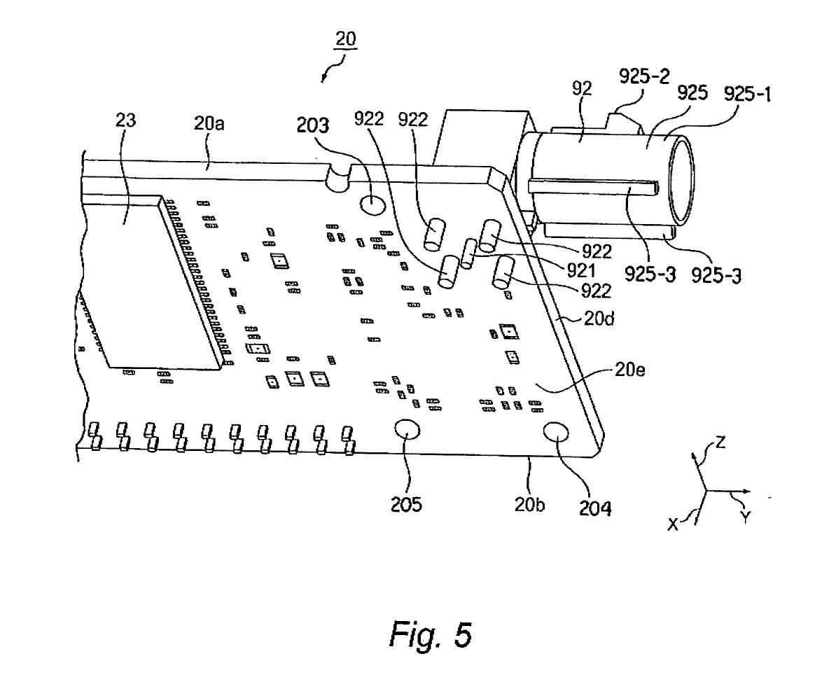

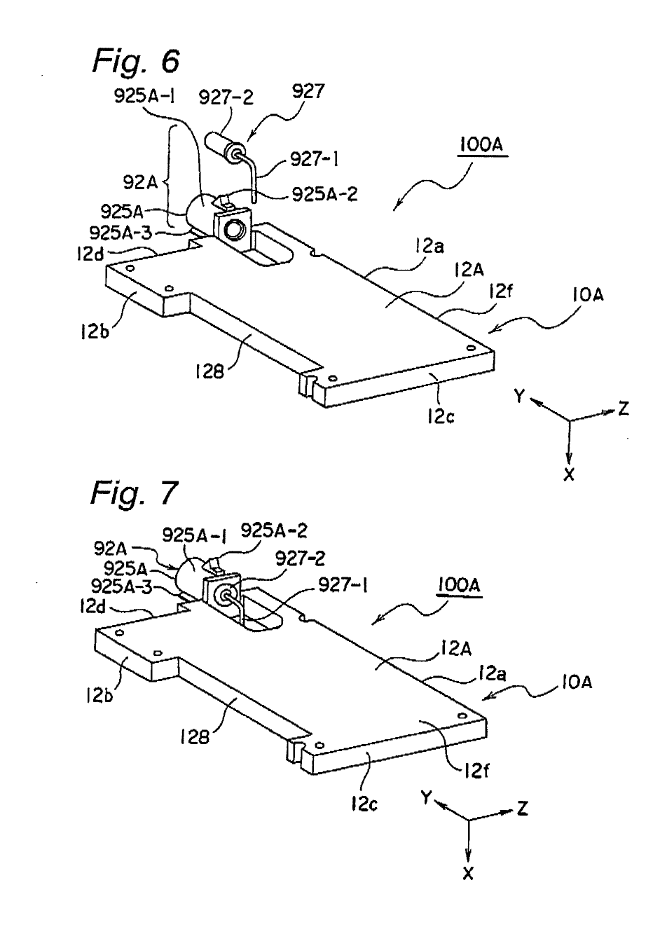

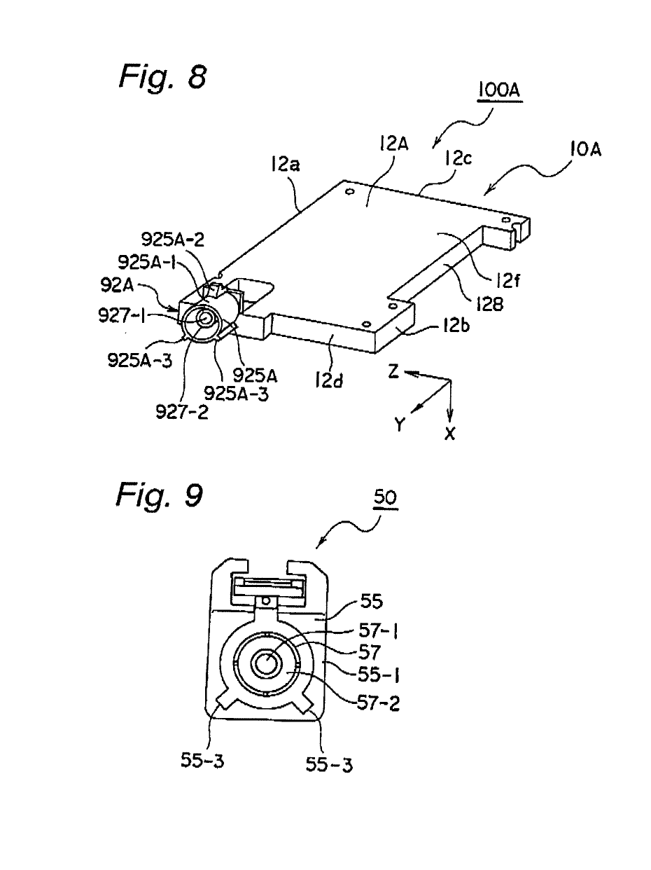

A tuner module 100A according to an embodiment will be described referring to FIGS. 6 to 8. The tuner module 100A has a similar structure to that of the tuner module 100 shown in FIG. 1 except for the following items. That is, a rear chassis, a metallic chassis, and an RF connector are changed which will be discussed later. As a consequence, such Document numerals as “10A”, “12A”, and “92A” are assigned to the metallic chassis, rear chassis, and the RF connector, respectively. Components similar to those in the antenna apparatus 10 will be denoted by the same Document numerals and repetitive explanations for those will be omitted.

The RF connector 92A includes an RF housing 925A and an RF signal transmitting member 927. The RF signal transmitting member 927 is housed in the RF housing 925A.

As shown in FIG. 6, the RF housing 925A of the RF connector 92A is die-cast-molded together with the rear chassis 12A. This reduces the number of parts.

The RF connector 92A is designed to couple to the mating connector 50. The illustrated RF connector 92A has a male connector, and the mating connector 50 has a female connector. One end of a coaxial cable 60 is connected the mating connector 50. The other end of the coaxial cable 60 is connected an antenna device (not shown).

As shown in FIGS. 6 to 8, the RF housing 925A includes a cylindrical RF outer casing 925A-1, a claw 925A-2 arranged on the outer wall of the RF outer casing 925A-1, and a pair of guide projecting strips 925A-3 arranged on the outer wall of the RF outer casing 925A-1.

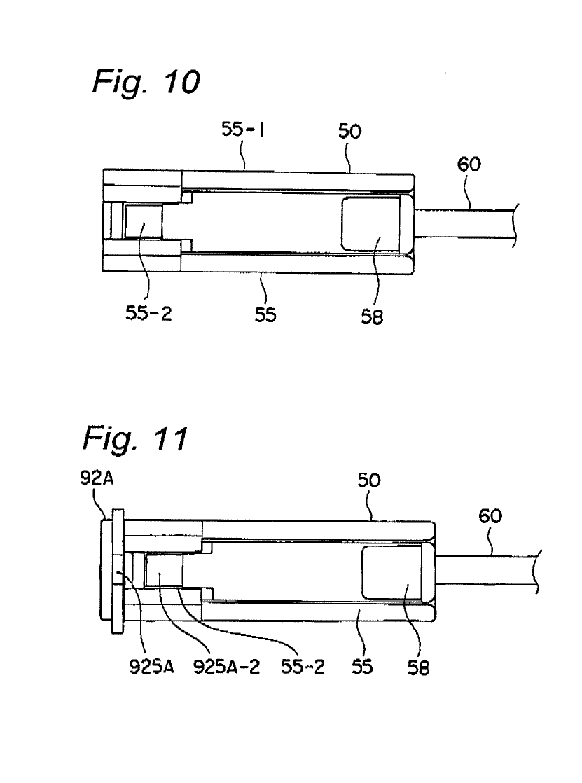

As shown in FIGS. 9 and 10, the mating connector 50 includes a mating housing 55 and a mating signal transmitting member 57. The mating signal transmitting member 57 is accommodated in the mating housing 55.

The mating housing 55 includes a mating outer casing 55-1 having a cylindrical space, a hole 55-2 formed in the mating outer casing 55-1, and a pair of guide grooves 55-3 arranged on the inner wall of the mating outer casing 55-1.

In a case where the mating connector 50 is fitted to the RF connector 92A, the pair of guide projecting strips 925A-3 is inserted and slid into the pair of guide grooves 55-3, and as shown in FIG. 11, the claw 925A-2 is engaged into the hole 55-2.

The claw 925A-2 is disengaged from the hole 55-2 by pushing an operation part 58 arranged on the mating housing 55.

Referring to FIGS. 6 to 8 again, the RF signal transmitting member 927 includes an RF core conductor 927-1 and an RF insulating body 927-2 arranged between the RF core conductor 927-1 and the RF housing 925A.

Similarly, as shown in FIG. 9, the mating signal transmitting member 57 includes a mating core conductor 57-1 and a mating insulating body 57-2 arranged between the mating core conductor 57-1 and the mating outer conductor 55.

As shown in FIG. 11, when the mating connector 50 is coupled to the RF connector 92A, the RF housing 925A and the mating housing 55 are electrically connected each other and the RF core conductor 927-1 and the mating core conductor 57-1 are electrically connected each other.

The RF signal transmitting member 927 is mounted on the RF housing 925A subsequent to a process for assembling the tuner module 100A.

The RF core conductor 927-1 is inserted into a through hole (not shown) in the RF input part 209 of the printed circuit board 20. The RF core conductor 927-1 and the through hole are electrically connected each other on the front face 20e of the printed circuit board 20 by soldering (not shown).

Therefore, soldering is applied only in a single position when the RF connector 92A is mounted on the printed circuit board 20. This reduces the number of assembling steps.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

For example, while a tuner module mounted on the major face of the main board with the longitudinal mount has been described in the above embodiment, the invention is also applicable to a tuner module mounted on the major face of the main board with the face-down mount. In this case, the first chassis 11 is used as a lower chassis and the second chassis 12A is used as an upper chassis. In this case, the X-axis direction represents the up-down direction, the Y-axis direction represents the right-left direction, and the Z-axis direction represents the front-rear direction. A plurality of connector pins mounted on the printed circuit board extends downward along the X-axis direction toward the major face of the main board.

The chassis 12 may be made of any conductive materials other than metal.

The invention is suited for tuner modules in vehicle-mounted digital radio receivers that are particularly requested to be downsized, as well as general radio receivers where the RF housing of an RF connector is die-cast-molded together with a metallic chassis.

The disclosure of Japanese Patent Application No. 2008-156188 filed Jun. 16, 2008 including specification, drawings and claims is incorporated herein by Document in it is entirety.

What is claimed is:

1. A tuner module adapted to demodulate a signal received by an antenna device, the tuner module comprising:
a die-casted chassis made of a conductive material and monolithically having a tubular part;
a circuit board disposed in the chassis;
an electric device mounted on the circuit board; and
a signal transmitting member coaxially disposed in the tubular part and constituting a coaxial connector with the tubular part, the signal transmitting member being electrically connected to the electric device to transmit the signal received by the antenna device to the electric device.

2. The tuner module set forth in claim 1, wherein:
the chassis includes a first part and a second part sandwiching the circuit board; and
the first part monolithically has the tubular part.

3. The tuner module set forth in claim 1, wherein:
the signal transmitting member includes:
a conductive core wire configured to transmit the signal to the electric device; and
a dielectric member surrounding the conductive core wire.

4. The tuner module set forth in claim 1, wherein:
the coaxial connector is adapted to be coupled to a mating connector having a hole; and
the tubular part is formed with a claw adapted to be engaged with the hole when the coaxial connector is coupled to the mating connecter.

5. The tuner module set forth in claim 4, wherein:
the tubular part is formed with a guide projection on an outer circumferential face thereof adapted to be inserted into a guide slit formed on the mating connector, when the coaxial connector is coupled to the mating connecter.

6. The tuner module set forth in claim 1, wherein:
the signal transmitting member is configured to transmit a radio frequency signal.

7. The tuner module set forth in claim 7, wherein:
the chassis is configured to electromagnetically shield the electronic device.

8. A method of assembling a tuner module adapted to demodulate a signal received by an antenna device, the method comprising:
die-casting a chassis with a conductive material so as to monolithically have a tubular part;
disposing a circuit board mounting an electric device thereon in the chassis;
disposing a signal transmitting member configured to transmit the signal in the tubular part coaxially so as to constitute a coaxial connector with the tubular part; and
connecting the signal transmitting member to the electric device electrically.
